(19) United States
(12) Patent Application Publication
(10) Pub. No.: US 2025/0065158 A1
(43) Pub. Date: Feb. 27, 2025

(54) SAFE ACCESS SYSTEM

(71) Applicant: Deuer Development, Moraine, OH (US)

(72) Inventors: Sheri R. O'Dell, Kettering, OH (US); Joseph F. Deuer, Kettering, OH (US)

(21) Appl. No.: 18/726,634

(22) PCT Filed: Jul. 5, 2023
(86) PCT No.: PCT/US2023/069619

§ 371 Date: Jul. 3, 2024

Related U.S. Application Data
(60) Provisional application No. 63/447,151, filed on Feb. 21, 2023.
(60) Provisional application No. 63/358,326, filed on Jul. 5, 2022.

(51) Int. Cl. A62B 35/00; A62B 1/06

(52) U.S. Cl. CPC A62B 35/0068; A62B 35/005; A62B 1/06

(57) ABSTRACT

A safe access system, comprising: a main body configured to attach to mounting hardware on a structure to be accessed; a first connector attached to the main body and configured for connecting to a vertical lifeline; and a second connector attached to the main body and configured for connecting to a power ascender line.

### BACKGROUND

Individuals working at elevated heights (e.g., telecom towers, utility structures, broadcast antennas, wind energy towers, etc.) require 100% fall protection. Typically, this requires the use of a vertical lifeline. A vertical lifeline is a line (e.g., high-strength synthetic or wire rope) that is anchored at both the top and the bottom of a defined climb path of the structure being accessed. The worker accessing the structure wears a safety harness to which a rope grab fall arrestor is attached. The rope grab fall arrestor is the connector between the worker's safety harness and the vertical lifeline. Rope grab fall arrestors automatically track the user up and down the vertical lifeline, thus stopping a fall by engaging (i.e., locking onto the vertical lifeline) in the event a fall occurs.

The vertical lifeline is anchored at the top of the climb path by a head assembly and mounting hardware that can be temporarily or permanently attached to the structure. The mounting hardware is attached to the structure being accessed and the head assembly, to which the vertical lifeline is connected, attaches to the mounting hardware. The mounting hardware is specific to the structure being accessed and has a standardized configuration for attaching to the head assembly.

Power ascenders are becoming more commonly used by individuals working at elevated heights. A power ascender works as a personal lift that climbs an ascender line (e.g., rope, cable, etc.) that is anchored at the top of the structure being accessed. The power ascender connects to the worker's safety harness and carries the individual up the power ascender line. The vertical lifeline and the power ascender line are separate lines. It is not always easy, however, to safely mount two separate lines at the top of the structures being accessed due to space constraints, load rating requirements, etc.

### SUMMARY

The following is a brief summary of subject matter that is described in greater detail herein. This summary is meant to provide some examples and is not intended to be limiting of the scope of the invention in any way. For example, any feature included in an example of this summary is not required by the claims, unless the claims explicitly recite the feature. Also, the features, components, steps, concepts, etc. described in examples in this summary and elsewhere in this disclosure can be combined in a variety of ways. Various features and steps as described elsewhere in this disclosure can be included in the examples summarized here.

Described herein are various implementations of a safe access system and methods for anchoring lines (e.g., a vertical lifeline, a power ascender line, power ascender back-up safety line, etc.) to a structure to be accessed. In some implementations, the system is a universal safe access system and anchorage for cable safe climb and power ascender integration. In some implementations, the system has optional cable safe climb system attachments in combination with power ascender anchorage.

In some implementations, a safe access system (e.g., dual climb safety and ascender anchorage) includes a head assembly or anchorage configured to attach to mounting hardware or directly to a structure to be accessed. In some implementations, the mounting hardware is part of, or integrated within the safe access system. In some implementations, the safe access system is configured to mount to mounting hardware already attached to a structure to be accessed. In some implementations, the head assembly or anchorage has a universal mounting configuration for mounting to a variety of mounting hardware. In some implementations, the head assembly is configured to attach to a vertical lifeline, a power ascender line, a power ascender back-up safety line, or combinations thereof. In some implementations, the head assembly is also configured to provide a safety tie-off transition point. In some implementations, the head assembly is configured to attach the vertical lifeline, the power ascender line, the power ascender back-up safety line, or combinations thereof with sufficient spacing between the lines for proper operation of a specific power ascender and to ensure proper line management (i.e., avoiding lines becoming entangled).

In some implementations, a safe access system includes a main body configured to attach to mounting hardware on a structure to be accessed and one or more connectors for mounting lines to the main body. In some implementations, the main body has an open head configuration that allows for visual inspection of the connectors and components associated with the connectors from a location external to the main body. The open head configuration allows for easy visual inspection of the connectors and associated components to ensure the safe access system is in safe working condition.

In some implementations, a first connector is attached to the main body and configured for connecting to a vertical lifeline and a second connector is attached to the main body and configured for connecting to a power ascender line. In some implementations, the safe access system includes a third connector attached to the main body and configured for use as a safety tie-off transition point. In some implementations, the safe access system includes a third connector attached to the main body and configured to support a power ascender back-up safety line.

In some implementations, the second connector is positioned on an arm movable relative to the main body. In some implementations, the arm is pivotable about a horizontal axis between a first upright position and a second extended position. In some implementations, the arm is pivotable about a vertical axis. In some implementations, the arm is moveable (e.g., slideable) along a longitudinal axis of the arm between a first retracted position and a second extended position. In some implementations, the arm is moveable (e.g., slideable) along a longitudinal axis of the arm between one or more intermediate positions between the first retracted position and the second extended position. In some implementations, the moveable arm is configured to lock in one or more of the first retracted position, the second extended position, and one or more intermediate positions. In some implementations, the second connector is positioned on an arm that is axially removable from the main body.

In some implementations, one or more of the connectors can include a biasing element. In some implementations, the first connector includes a biasing element configured to dampen a load applied to the first connector. In some implementations, the biasing element is configured to apply a tensile force to a vertical lifeline or power ascender back-up safety line. In some implementations, the biasing element is a metal coil spring. In some implementations, the first connector is load rated to 5000 lbf or greater and the second connector is load rated to 3600 lbf or greater. In some implementations, the first connector is spaced apart from the second connector a distance in the range of 3 inches to 30 inches.

In some implementations, the main body has a proximal end that attaches to the mounting hardware and a distal end opposite the proximal end, and wherein the second connector is spaced distally from the distal end a distance in the range of 12 inches to 36 inches. In some implementations, the main body has a bottom wall that includes a plurality of mounting holes, each mounting hole configured to receive either of the first or the second connector.

An example method of anchoring a vertical lifeline and a power ascender line at the top of a climb path on a structure includes attaching a head assembly having a main body to mounting hardware on the structure, attaching the vertical lifeline to the main body at a first location, and attaching the power ascender line to the main body at a second location. In some implementations, the head assembly has a universal mounting configuration for mounting to a variety of mounting hardware.

In some implementations, the first location is spaced apart from the second location a distance in the range of 3 inches to 36 inches. In some implementations, the second location is located on a movable arm. In some implementations, the method includes pivoting the movable arm to an extended position. In some implementations, the method includes sliding the movable arm along a longitudinal axis to a plurality of positions relative to the main body. In some implementations, the method includes locking the moveable arm in one of the plurality of positions. In some implementations, the method includes pivoting the movable arm about a vertical axis.

In some implementations, the method includes attaching a safety tie off to the main body at a third location. In some implementations, the method includes attaching a power ascender back-up line to the main body at a third location.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a simplified exploded illustration of an exemplary dual climb safety and ascender anchorage system for use on a structure to be accessed.

FIG. 2 is side view of the exemplary head assembly of FIG. 1.

FIG. 3 is an end view of the exemplary head assembly of FIG. 1.

FIG. 4 is a side view of another exemplary head assembly.

FIG. 5 is an end view of the exemplary head assembly of FIG. 4.

FIG. 6 is a side view of another exemplary head assembly.

FIG. 7 is a side view of another exemplary head assembly.

FIG. 8 is a bottom view of the exemplary head assembly of FIG. 8;

FIG. 9 is a side view of another exemplary head assembly.

FIG. 10 is a side view of another exemplary head assembly.

FIG. 11 is an end view of the exemplary head assembly of FIG. 8.

FIG. 12 is a bottom view of the exemplary head assembly of FIG. 8.

### DETAILED DESCRIPTION

Various implementations pertaining to a safe access system are described herein. In the following description, for purposes of explanation, numerous specific details are set forth in order to provide a thorough understanding of one or more aspects. It may be evident, however, that such aspect(s) may be practiced without these specific details. Further, it is to be understood that functionality that is described as being carried out by certain system components may be performed by multiple components. Similarly, for instance, a component may be configured to perform functionality that is described as being carried out by multiple components.

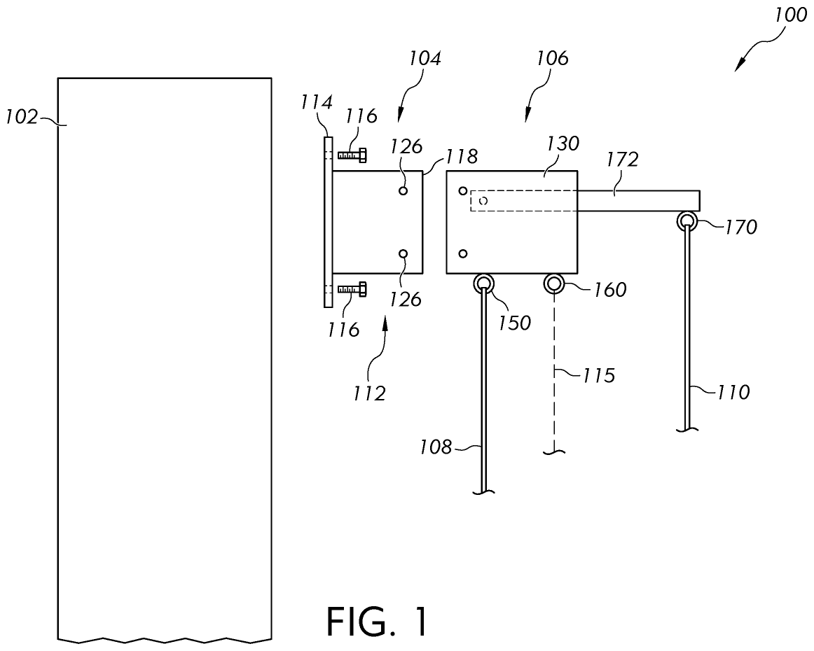

FIG. 1 is an illustration of an example safe access system 100 for use on a structure 102 that will be accessed by an individual. The safe access system 100 (e.g., a dual climb safety and ascender anchorage system) can include mounting hardware 104 configured to attach to the structure 102 and a head assembly or anchorage 106 configured to attach to the mounting hardware 104. In some implementations, the safe access system 100 disclosed herein meets Personal Fall Arrest System requirements defined by ANSI/ASSP Z359 standard (2023) and Rope Access System requirements defined by ANSI/ASSP Z459.1 (2023). In some implementations, the safe access system 100 is a universal safe access system and anchorage for cable safe climb and power ascender integration that has a universal mounting configuration for mounting to a variety of mounting hardware. In some implementations, the safe access system 100 can use a variety of optional cable safe climb system attachments in combination with power ascender anchorage.

The head assembly 106 can support a vertical lifeline 108 and a power ascender main line 110. In some implementations, the head assembly 106 can additionally, or alternatively, support a power ascender back-up safety line 115 (i.e., vertical lifeline). In some implementations, the safe access system 100 can include a bottom anchor assembly (not shown) configured to anchor the vertical lifeline 108 at an end opposite the head assembly 106 (e.g., at a position below the head assembly). In some implementations, the safe access system 100 can include a bottom anchor assembly (not shown) configured to anchor the power ascender back-up safety line 115 at an end opposite the head assembly 106 (e.g., at a position below the head assembly). In some implementations, the head assembly 106 can mount onto mounting structure that is already in place at the top of a defined climb path for structure (e.g., a bracket that already supports a vertical lifeline). Thus, the head assembly 106 can be used, for example, to anchor the power ascender main line 110, a power ascender back-up safety line 115, and/or provide a safety tie-off location.

The structure 102 being accessed is illustrated as a cylindrical pole in FIG. 1. The structure 102 being accessed, however, can be a wide variety of structures, such as but not limited to, telecom towers, utility structures, broadcast antennas, light poles, wind energy towers, steel erections, marine maintenance, oil and gas rigs, etc. It will be understood that accessing the structure 102 may require ascending a structure that extends upward from ground level or descending a structure that extends below ground level.

The mounting hardware 104 is specifically configured to mount (directly or indirectly) onto the type of structure being accessed. Since the structure 102 can be a wide variety of structures, the mounting hardware 104 can be configured in a variety of ways. For example, the mounting hardware 104 can be configured to mount to a ladder, a monopole, a round climbing leg, an angle climbing leg, a lightweight tower, a pole, or other structure being accessed. The mounting hardware 104 can be configured to mechanically mount onto the structure 102 via fasteners, brackets, bars, etc. In other implementations, the mounting hardware 104 can mount onto the structure via a magnetic force, such as for example by utilizing one or more rare earth magnets that magnetically couples onto the structure 102. Furthermore, in some implementations of the safety access system 100, the head assembly 106 can be configured to magnetically couple directly to the structure 102 without the use of mounting hardware 104. For example, the head assembly 106 can include one or more rare earth magnets that can directly magnetically couple onto the structure 102.

In the illustrated implementation, the mounting hardware 104 is a bracket 112 having a flange 114 configured to be attached to the structure 102 by fasteners 116. The bracket 112 further includes a projecting portion 118 extending outward from the flange 114. The projecting portion 118 is configured to support the head assembly 106 and can be configured in a variety of ways. In the illustrated implementation, the projecting portion 118 is a generally rectangular projection including mounting holes 126 for receiving fasteners (not shown) for attaching the head assembly 106 to the projecting portion 118.

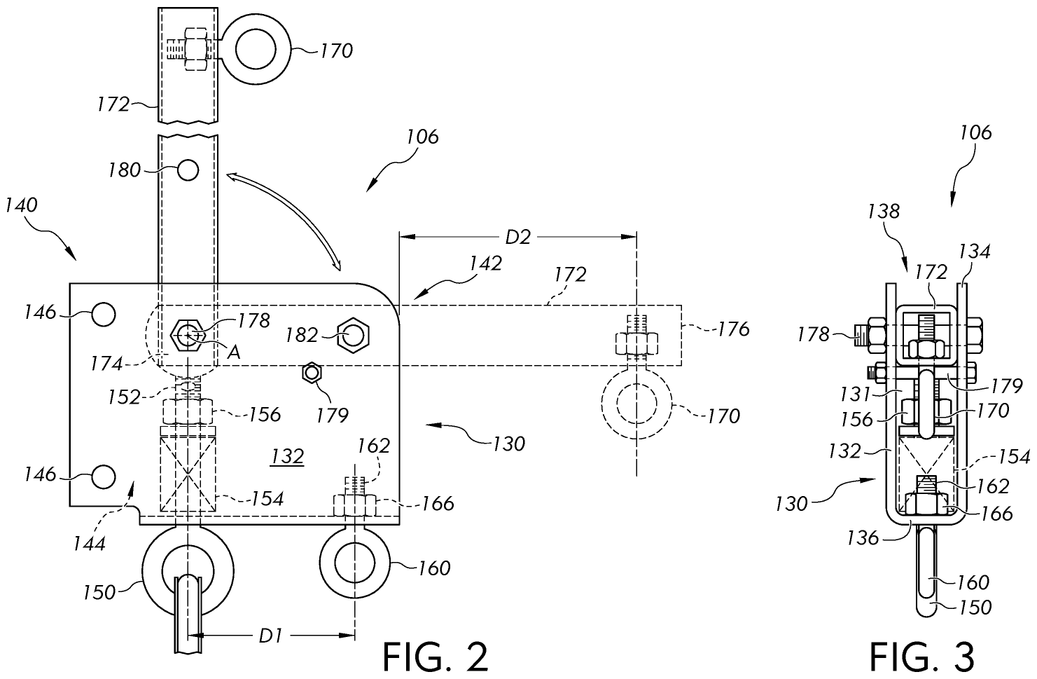

Referring to FIGS. 2-3, the example head assembly 106 for the safe access system 100 is illustrated. The head assembly 106 is configured to attach to the mounting hardware 104 and support the vertical lifeline 108 and the power ascender line 110. The head assembly 106 can be configured in a variety of ways. In the illustrated implementation, the head assembly 106 includes a main body 130 formed as a U-shaped channel 131. The main body 130 includes a first side wall 132, a second side wall 134 parallel to the first side wall 132, a bottom wall 136 extending perpendicular to and connecting the first side wall 132 and the second side wall 134, and an open top end 138 opposite the bottom wall 136. In some implementations, the main body 130 includes a proximal end 140 configured to attach to the mounting hardware 104 and a distal end 142 opposite the proximal end 140.

The proximal end 140 can be configured to attach to the mounting hardware 104 in a variety of ways. In some implementations, the first side wall 132 and the second side wall 134 form a vertical channel 144 that receives the projecting portion 118 of the mounting hardware 104. Each of the first side wall 132 and the second side wall 134 include a pair of mounting holes 146 for attaching the head assembly 106 to the projecting portion 118. When the head assembly 106 is properly positioned on the projecting portion 118, the mounting holes 146 at the proximal end 140 align with the mounting holes 126 on the projecting portion 118 for receiving the fasteners 128 therethrough.

In some implementations, the attachment configuration for attaching the head assembly 106 to the mounting hardware 104 described above is a standardized configuration for attaching to a wide variety of mounting hardware used for structures to be accessed. Thus, the head assembly 106 can be configured to have a universal mounting configuration for mounting to a variety of mounting hardware. For example, in some implementations, the attachment configuration meets the Telecommunications Industry Association (TIA) 222 standard. In particular, the mounting holes 146 are vertically spaced apart at 4 inches center-to-center and configured to receive two 0.5-inch diameter fasteners (e.g. bolts). Since the type of mounting hardware varies based on what type of structure is being accessed, having a universal configuration between the head assembly 106 to the mounting hardware 104 allows the head assembly 106 to be used with the different mounting hardware for the various structures. In other implementations, the attachment configuration may not be a universal configuration but customized or specialized for a specific application.

In some implementations, the head assembly 106 includes a first connector 150 configured to support the vertical lifeline 108 at a fixed position. The first connector 150 can be configured in a variety of ways, including the type of connector used to attach the vertical lifeline 108 to the head assembly 106. The vertical lifeline 108 can be a variety of line types, such as high strength polyester rope, synthetic rope, wire rope, webbing, or other suitable flexible line type. The first connector 150 can be suitable for connecting to any suitable vertical lifeline type.

In some implementations, the first connector 150 is an eye bolt. In other implementations, however, the first connector 150 can be any suitable connector, such as for example, a swaged connector, shackle, clevis, carabiner, quick connect link, or other suitable personal protective equipment or material handling rigging attachments. In some implementations, the first connector 150 is positioned adjacent the proximal end 140 in the bottom wall 136 such that the vertical lifeline 108 can attach to the bottom of the head assembly 106. The first connector 150 must be properly load rated for use as a vertical lifeline top anchor. In some implementations, the first connector 150 has a load rating of 5000 lbf (22.2 kN) or greater, 5250 lbf (23.4 kN) or greater, or 5500 lbf (24.5 kN) or greater. In some implementations, the first connector 150 has a load rating of twice the maximum arresting force (i.e., the peak dynamic force exerted on a body while a fall is being arrested) or greater. In some implementations, the first connector 150 meets the Personal Fall Arrest System requirements defined by ANSI/ASSP Z359 standard (2023)

In some implementations, the head assembly 106 is configured such that the first connector 150 is load dampened. For example, in some implementations, the first connector 150 includes a shaft 152 that extends upward into the U-shaped channel 131 between the first side wall 132 and the second side wall 134. In some implementations, a biasing element 154 can be received onto the shaft 152 and sandwiched between the bottom wall 136 and a stop 156. In some implementations, the shaft 152 has exterior threads and the stop 156 is a nut threadably coupled with the shaft 152.

The biasing element 154 can be configured in a variety of ways (e.g., spring, elastomeric sleeve, bellows, etc.). In some implementations, the biasing element 154 is a metal coil spring. Due to prolonged exposure to environmental elements in many of the applications for the safe access system, use of a metal biasing element can provide improved durability as compared to a rubber or synthetic material.

When configured with a load dampening feature, the first connector 150 can dampen a load applied to the vertical lifeline 108 (and the user) during a fall event, and thus decrease the load the user experiences. Furthermore, the vertical lifeline 108 should be held in tension for proper use of a fall arrestor. In some implementations, the biasing element 154 is configured to apply and keep a proper tensile load (e.g., 200 lb tensile load) on the vertical lifeline 108. The biasing element 154 can be configured to maintain the tensile load on the vertical lifeline 108 even when the structure being accessed sways or deflects in the direction of the vertical lifeline 108 (e.g., in response to wind).

In some implementations, the head assembly 106 includes a second connector 160 configured to support the power ascender back-up safety line 115 at a fixed position, or act as an alternative position to mount the power ascender main line 110. The second connector 160 can be configured in a variety of ways, including the type of connector used to attach the power ascender back-up safety line 115 or main line 110 to the head assembly 106 or be used as a safety tie-off transition point. In some implementations, the second connector 160 can include a biasing element (not shown) in a similar manner as described for the first connector 150, to provide a tensile force to the power ascender back-up safety line 115. The power ascender back-up safety line 115 may be a variety of line types, such as high strength polyester rope, for example. The second connector 160 can be suitable for connecting to any suitable power ascender line type (e.g., main hoisting line or back-up safety line).

In some implementations, the second connector 160 is an eye bolt. In other implementations, however, the second connector 160 can be any suitable connector, such as for example, a swaged connector, shackle, clevis, carabiner, quick connect link, or other suitable personal protective equipment or material handling rigging attachments. In some implementations, the second connector 160 is positioned toward or adjacent the distal end 142 in the bottom wall 136 such that the power ascender line 110 can attach to the bottom of the head assembly 106. In some implementations, the second connector 160 is properly load rated for use as a power ascender top anchor. In the illustrated implementation, the second connector 160 has a load rating of 3600 lbf (16.0 kN) or greater, 4000 lbf (17.8 kN) or greater, or 4500 lbf (20.0 kN) or greater. In some implementations, the second connector 160 has a load rating in the range of 3600 lbf (16.0 kN) to 5000 lbf (22.2 kN). In some implementations, the second connector 160 meets one or more of the Rope Access System requirements defined by ANSI/ASSP Z459.1 (2023), the Personal Fall Arrest System requirements defined by ANSI/ASSP Z359 standard (2023), or the Rescue Anchorage System requirements defined by ANSI/ASSP Z459.1 (2023).

In some implementations, the second connector 160 includes a shaft 162 that extends upward into the U-shaped channel 131 between the first side wall 132 and the second side wall 134. A nut 166 is threadably received onto the shaft 162 to secure the second connector 160 to the main body 130. In some implementations, the second connector 160 is spaced apart from the first connector 150 on the bottom wall 136 a distance D1. The distance D1 can be any suitable distance. In some implementations, the distance D1 is sufficient to prevent the vertical lifeline 108 and the power ascender line 110 from becoming entangled with each other during use. In addition, in some implementations, the distance D1 is sufficient to allow use of a power ascender (not shown) with the power ascender line 110 without the power ascender (not shown) contacting the vertical lifeline 108 during use. Thus, the distance D1 can be selected as required for proper operation of a specific power ascender and to ensure proper line management (i.e., avoiding lines becoming entangled). In some implementations, the distance D1 is in the range of 3 inches to 36 inches, in the range of 5 to 30 inches, or in the range of 10 to 25 inches. In some implementations, the distance D1 is 3 inches or greater, 5 inches or greater, or 10 inches or greater.

In some implementations, the head assembly 106 includes a third connector 170 configured to support the power ascender line 110 at a fixed position. In some implementations, the third connector 170 is configured to be used as an alternative connector to the second connector 160 for the power ascender line 110. In some implementations, the third connector 170 is configured to be used for the power ascender line 110 and the second connector 160 is configured to be used for a back-up safety line 108 (i.e., fall protection) for the power ascender. For example, a user can use the third connector 170 for the power ascender line 110 and use the second connector 160 for a fall protection line rather than use the vertical lifeline 108 attached to the first connector 150.

The third connector 170 can be configured in a variety of ways, including the type of connector used to attach the power ascender main line 110 to the head assembly 106. The power ascender line 110 can be a variety of line types, such as high strength synthetic rope, for example. The third connector 170 can be suitable for connecting to any suitable power ascender main line type.

In some implementations, the third connector 170 is an eye bolt. In other implementations, however, the third connector 170 can be any suitable connector, such as for example, a swaged connector, shackle, clevis, carabiner, quick connect link, or other suitable personal protective equipment or material handling rigging attachments. In some implementations, the third connector 170 is positioned on a movable arm 172. In other implementations, the third connector 170 can be positioned adjacent on the second connector 160 on the main body 130.

The movable arm 172 can be configured to position the third connector 170 distally outward from the distal end 142 of the main body 130. The movable arm 172 can be configured in a variety of ways, including, but not limited to. the size, length, and cross-section shape of the movable arm 172. In some implementations, the movable arm 172 is formed as a rectangular or square tube having a proximal end 174 and a distal end 176 opposite the proximal end 174. In some implementations, the proximal end 174 is pivotably connected to the main body 130 by a pivot pin or bolt 178. The movable arm 172 can pivot about a horizontal axis A defined by the pivot pin 178 between an upright first position (showed in solid line in FIG. 2) and an extended second position (showed in dashed line in FIG. 2). The main body 130 can include a cross pin or bolt 179 that acts as a stop to prevent the movable arm 172 from pivoting past the second position, which is 90 degrees, or approximately 90 degrees, from the first position.

In some implementations, the movable arm 172 can be configured to lock in the extended second position. The movable arm 172 can be configured to lock in the extended second position in a variety of ways. In some implementations, the movable arm 172 includes a cross hole 180 that aligns with locking apertures 182 in the main body 130 when the movable arm 172 is in the extended second position. A fastener (e.g., a bolt, clevis, pin, ball lock, etc.) can be received through the cross hole 180 and locking apertures 182 to lock the movable arm 172 in the extended second position.

In some implementations, the third connector 170 is positioned at or near the distal end 176 of the movable arm 172 such that the eyelet or other connection point, is facing downward (similar direction to the first and second connectors) when the movable arm 172 is in the extended second position. The third connector is positioned on the movable arm 172 a distance D2 from the distal end 142 of the main body 130 when the movable arm 172 is in the extended second position. The distance D2 can be selected as required for proper operation of a specific power ascender and to ensure proper line management (i.e., avoiding lines becoming entangled). In some implementations, the distance D2 is in the range of 3 inches to 36 inches, in the range of 8 inches to 36 inches, in the range of 10 to 36, or in the range of 12 inches to 36 inches. In some implementations, the distance D2 is 3 inches or greater, 8 inches or greater, 10 inches or greater, or 12 inches or greater. In some implementations, the third connector 170 meets the Rope Access System requirements defined by ANSI/ASSP Z459.1 (2023).

In use, the head assembly 106 can attach, in a standardized manner, to the mounting hardware 104 on a structure 102 to be accessed or, in some implementations, can attach directly to the structure 102. Because the head assembly 106 uses a standardized attachment configuration, the head assembly 106 can be used to access a wide variety of structures. The head assembly 106 provides a single, fixed assembly for mounting both the vertical lifeline 108 and the power ascender line 110 that is properly load rated for both applications. The head assembly 106 provides this single, fixed mounting for both the vertical lifeline 108 and the power ascender line 110 at the top of the defined climb path for structure 102. Furthermore, the first connector 150 for the vertical lifeline 108 is sufficiently spaced from the connectors 160, 170 for the power ascender line 110 to ensure the vertical lifeline 108 and power ascender line 110 do not become entangled during use or that the power ascender (not shown) does not contact the vertical lifeline 108 while ascending or descending the power ascender line 110. Thus, the head assembly 106 safely mounts both the vertical lifeline 108 and power ascender line 110 along a static defined climb path.

In some implementations, the head assembly 106 includes the movable arm 172 that provides an alternative connection point for the power ascender line 110. The movable arm 172 can be positioned such that the third connector 170 is positioned outward from the main body 130 of the head assembly 106 to provide additional spacing for the power ascender line 110 to avoid obstructions from the structure 102 along the climb path. When the third connector 170 is not used, the movable arm 172 can be moved out of the way to a stored (e.g., upright) position to allow access above the head assembly 106.

In some implementations, the head assembly 106 can include the second connector 160. Either the second connector 160 or the third connector 170 can also be configured as a safety tie-off transition point. A safety tie-off transition point is an anchor location that can be used should the user need to leave the vertical lifeline 108, such as for example, to work at a location on the structure off of the defined climb path. In such a situation, the user's safety harness would have a lanyard, for example, with one end connected to the safety harness (e.g., via a D-ring) and the other end able to attach to the safety tie-off transition point. Once connected to the safety tie-off transition point, the user can disconnect from the vertical lifeline 108 and perform the necessary operations. Thus, the head assembly 106 provides a safety tie-off transition point (e.g., the second connector) along with a vertical lifeline connector (i.e., the first connector) and a power ascender line connector (e.g., the third connector).

Furthermore, in some implementations, the second connector 160 can be configured to support for a back-up safety line 115 at a fixed position. For example, the first connector 150 can be configured to support the vertical lifeline 108, the third connector 170 can be configured to support the power ascender line 110, and the second connector 160 can be configured to support the back-up safety line 115. The back-up safety line 115 can be a variety of line types, such as high strength polyester rope, synthetic rope, wire rope, webbing, or other suitable flexible line type. The second connector 160 can be suitable for connecting to any suitable vertical lifeline type. Thus, in some implementations, a user can utilize the power ascender line 110 connected at the third connection 170 and the back-up safety line 115 connected at the second connector 160 as an alternative to using the vertical lifeline connected at the first connector 150.

In some implementations, the main body 130 has an open head configuration that allows for easy visual inspection of the head assembly 106 to ensure the head assembly 106 is not damaged and is safe to use. The open head configuration allows for visual inspection of the connectors 150, 160, 170 and associated components (e.g., shafts, stops, biasing element, etc.) from a positioned external to the main body 130. For example, the open head configuration can allow for an unobstructed view of the connectors 150, 160, 170 and associated components. In some implementations, as shown in FIG. 3, the main body 130 is a U-shaped channel design that allows for easy visual inspection of the head assembly 106 from both above and from the end of the head assembly 106. Thus, the connectors 150, 160, 170 and associated components (e.g., shafts, stops, biasing element, etc.) can be easily visually inspected to ensure the connectors are properly secured and not damaged and the biasing element is functional (e.g., not overly compressed or broken). For example, in some implementations, the open head configuration allows for visual inspection by drone, climber, telescope, binoculars, camera, etc. by providing an unobstructed view to the connections and components being inspected.

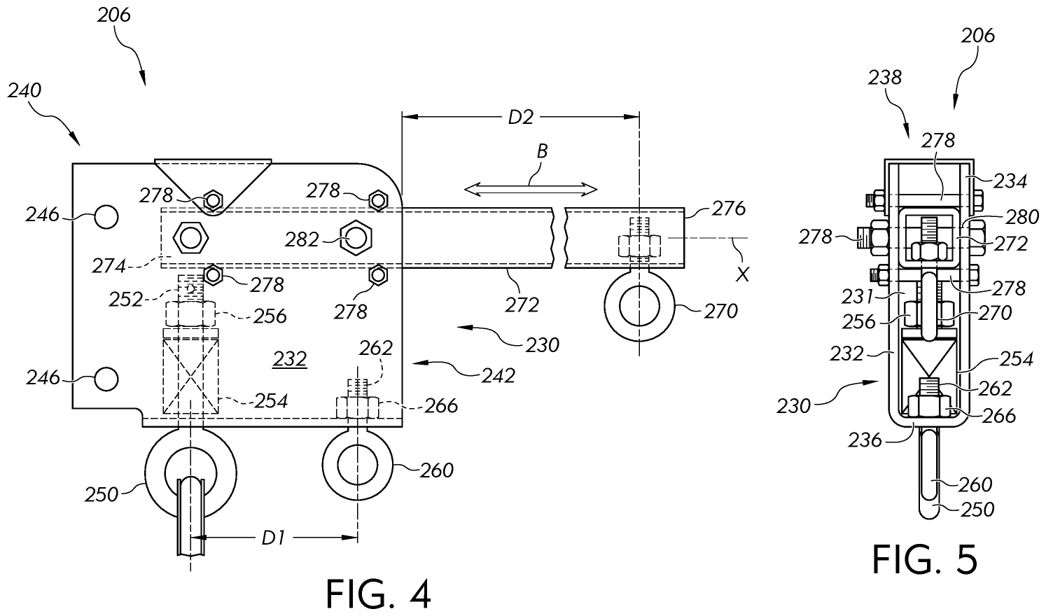

Referring to FIGS. 4-5, an example head assembly 206 for the safe access system 100 is illustrated. The head assembly 206 is configured similar to the head assembly 106 of FIGS. 2-3 except the head assembly 206 includes a removable arm 272. Except for the arm 272 being removable rather than pivotable, the description of the head assembly 106 applies equally to the head assembly 206. For example, in some implementations, the head assembly 206 includes a main body 230 having an open head configuration. In some implementations, the main body 230 is formed as a U-shaped channel 231 having a first side wall 232, a second side wall 234 parallel to the first side wall 232, a bottom wall 236 extending perpendicular to and connecting the first side wall 232 and the second side wall 234, and an open top end 238 opposite the bottom wall 236. The main body 230 can include a proximal end 240 configured to attach to the mounting hardware 104, or directly to the structure 102, and a distal end 242 opposite the proximal end 240.

In some implementations, the first side wall 232 and the second side wall 234 form a vertical channel 244 at the proximal end 240 that receives the projecting portion 118 of the mounting hardware 104. Each of the first side wall 232 and the second side wall 234 can include mounting holes 246 for attaching the head assembly 206 to the mounting hardware 104. In some implementations, the attachment configuration for attaching the head assembly 206 to the mounting hardware 104 is a standardized or universal configuration. For example, in some implementations, the attachment configuration meets the Telecommunications Industry Association (TIA) 222 standard. In particular, the mounting holes 246 are vertically spaced apart at 4 inches center-to-center and configured to receive two 0.5-inch diameter fasteners (e.g., bolts). Since the type of mounting hardware varies based on what type of structure is being accessed, having a universal configuration between the head assembly 106 to the mounting hardware 104 allows the head assembly 106 to be used with the different mounting hardware for the various structures. In other implementations, the attachment configuration may not be a universal configuration but customized or specialized for a specific application.

In some implementations, the head assembly 206 includes a first connector 250 configured to support the vertical lifeline 108 at a fixed position. In some implementations, the first connector 250 is an eye bolt. In other implementations, however, the first connector 250 can be any suitable connector. In some implementations, the first connector 250 is positioned adjacent the proximal end 240 in the bottom wall 236 such that the vertical lifeline 108 can attach to the bottom of the head assembly 206. In some implementations, the first connector 250 is properly load rated for use as a vertical lifeline top anchor. In some implementations, the first connector 250 has a load rating of 5000 lbf (22.2 kN) or greater, 5250 lbf (23.4 kN) or greater, or 5500 lbf (24.5 kN) or greater. In some implementations, the first connector 250 has a load rating of twice the maximum arresting force (i.e., the peak dynamic force exerted on a body while a fall is being arrested) or greater. In some implementations, the first connector 250 meets the Personal Fall Arrest System requirements defined by ANSI/ASSP Z359 standard (2023),

In some implementations, the first connector 250 includes a shaft 252 that extends upward into the U-shaped channel 231 between the first side wall 232 and the second side wall 234. In some implementations, a biasing element 254 can be received onto the shaft 252 and sandwiched between the bottom wall 236 and a stop 256. In some implementations, the shaft 252 has exterior threads and the stop 256 is a nut threadably coupled with the shaft 252. The biasing element 254 can be configured in a variety of ways (e.g., spring, elastomeric sleeve, bellows, etc.). In some implementations, the biasing element 254 is a metal coil spring.

In some implementations, the head assembly 206 includes a second connector 260 configured to support the power ascender line 110 and/or the back-up safety line 115 at a fixed position. In some implementations, the second connector 260 is an eye bolt. In other implementations, however, the second connector 260 can be any suitable connector. In some implementations, the second connector 260 can include a biasing element (not shown) in a similar manner as described for the first connector 256050, in order to provide a tensile force to the power ascender back-up safety line 115. In some implementations, the second connector 260 is positioned toward or adjacent the distal end 242 in the bottom wall 236 such that the power ascender line 110 or the back-up safety line 115 can attach to the bottom of the head assembly 206. In some implementations, the second connector 260 is properly load rated for use as a power ascender top anchor. In some implementations, the second connector 260 has a load rating of 3600 lbf (16.0 kN) or greater, 4000 lbf (17.8 kN) or greater, or 4500 lbf (20.0 kN) or greater. In some implementations, the second connector 160 has a load rating in the range of 3600 lbf (16.0 kN) to 5000 lbf (22.2 kN).

The second connector 260 includes a shaft 262 that extends upward into the U-shaped channel 231 between the first side wall 232 and the second side wall 234 and is connected to a stop 266. In some implementations, the shaft 262 has external threads and the stop 266 is a nut threadably received onto the shaft 262 to secure the second connector 260 to the main body 230.

In some implementations, the second connector 260 is spaced apart from the first connector 250 on the bottom wall 236 a distance D1. The distance D1 can be any suitable distance. In some implementations, the distance D1 is sufficient to prevent the vertical lifeline 108, and the power ascender line 110, or back-up safety line 115, from becoming entangled with each other during use. In addition, the distance D1 is also sufficient to allow use of a power ascender (not shown) with the power ascender line 110 without the power ascender (not shown) contacting the vertical lifeline 108 during use. Thus, the distance D1 can be selected as required for proper operation of a specific power ascender and to ensure proper line management (i.e., avoiding lines becoming entangled). In some implementations, the distance D1 is in the range of 3 inches to 36 inches, in the range of 5 to 30 inches, or in the range of 10 to 25 inches. In some implementations, the distance D1 is 3 inches or greater, 5 inches or greater, or 10 inches or greater.

In some implementations, the head assembly 206 includes a third connector 270 configured to support the power ascender line 110 at a fixed position. The third connector 270 can be used as an alternative connector to the second connector 260 for the power ascender line 110. In some implementations, the third connector 270 is an eye bolt. In other implementations, however, the third connector 270 can be any suitable connector, such as for example, a swaged connector, shackle, clevis, carabiner, quick connect link, or other suitable personal protective equipment or material handling rigging attachments.

In some implementations, the third connector 270 is positioned on the removable arm 272. The removable arm 272 can be configured to position the third connector 270 distally outward from the distal end 242 of the main body 230. The removable arm 272 can be configured in a variety of ways, including, but not limited to. the size, length, and cross-section shape of the removable arm 272. In some implementations, the removable arm 272 is formed as a rectangular or square tube having a longitudinal axis X, a proximal end 274, and a distal end 276 opposite the proximal end 274. In some implementations, the removable arm 272 is configured to slide axially relative to the main body 230, as shown by arrows B in FIG. 4, to remove the removable arm 272 from the head assembly 206 when not in use. In some implementations, the main body 230 includes two pairs of guide pins 278 that support the removable arm 272 is a generally horizontal position when the removable arm 272 is installed.

The removable arm 272 can be configured to lock in position when installed. In some implementations, the removable arm 272 includes a cross hole 280 that aligns with locking apertures 282 in the main body 230 when the removable arm 272 is installed. A fastener (e.g., a bolt) can be received through the cross hole 280 and locking apertures 282 to lock the removable arm 272 in position.

The third connector 270 can be positioned at or near the distal end 276 of the removable arm 272 such that eyelet, or other connection point, is facing downward (similar direction to the first and second connectors) when the removable arm 272 is installed. The third connector 270 is positioned on the removable arm 272 a distance D2 from the distal end 242 of the main body 230 when the removable arm 272 is installed. The distance D2 can be selected as required for proper operation of a specific power ascender and to ensure proper line management (i.e., avoiding lines becoming entangled). In some implementations, the distance D2 is in the range of 3 inches to 36 inches, in the range of 8 inches to 36 inches, in the range of 10 inches to 36 inches, or in the range of 12 inches to 30 inches. In some implementations, the distance D2 is 3 inches or greater, 8 inches or greater, 10 inches or greater, or 12 inches or greater.

In use, the removable arm 272 can be installed such that the third connector 270 is positioned outward from the main body 230 of the head assembly 206 to provide additional spacing for the power ascender line 110 to avoid obstructions on the structure 102 along the climb path. When the third connector 270 is not used, the removable arm 272 can be decoupled from the main body 230 and removed.

The second connector 260 or the third connector 270 can also be used as a safety tie-off transition point. A safety tie-off transition point is an anchor location that can be used should the user need to leave the vertical lifeline 108, such as for example, to work at a location on the structure off of the defined climb path. In such a situation, the user's safety harness would have a lanyard, for example, with one end connected to the safety harness (e.g., via a D-ring) and the other end able to attach to the safety tie-off transition point. Once connected to the safety tie-off transition point, the user can disconnect from the vertical lifeline 108 and perform the necessary operations. Thus, the head assembly 206 provides a safety tie-off transition point (e.g., the second connector) along with a vertical lifeline connector (i.e., the first connector) and a power ascender line connector (e.g., the third connector).

Furthermore, the second connector 260 can be configured for use as a support for a back-up safety line 115 at a fixed position. For example, the first connector 250 can be configured to support the vertical lifeline 108, the third connector 270 can be configured to support the power ascender line 110, and the second connector 260 can be used to support a back-up safety line 115. Thus, a user can use the power ascender line 110 with a power ascender and use the back-up safety line 115 connected to the second connector 260 as an alternative to using the vertical lifeline 108 connected to the first connector 250. The back-up safety line 115 can be a variety of line types, such as high strength polyester rope, synthetic rope, wire rope, webbing, or other suitable flexible line type. The second connector 115 can be suitable for connecting to any suitable vertical lifeline type.

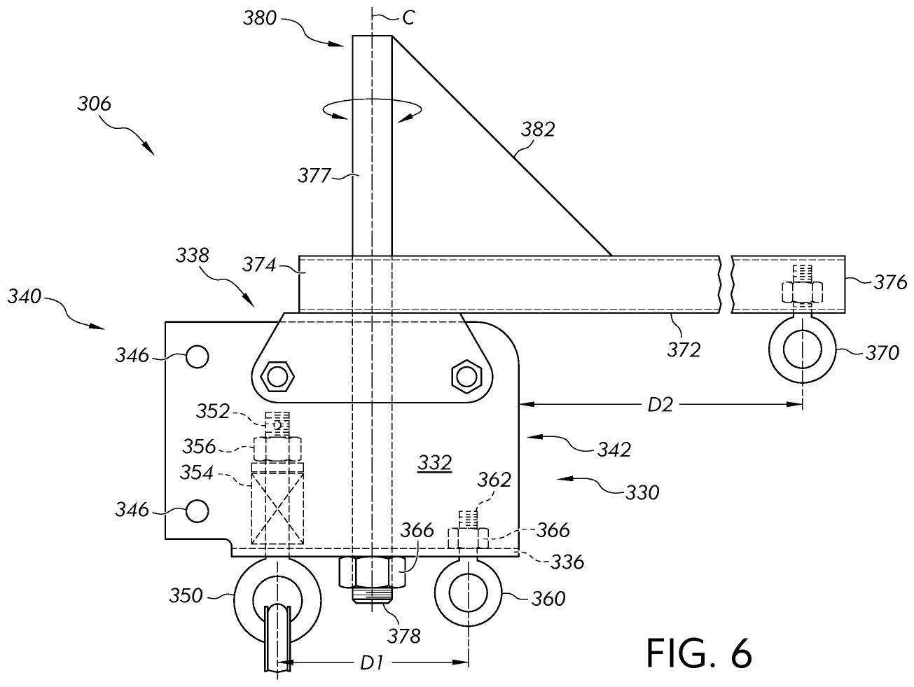

Referring to FIG. 6, an example head assembly 306 for the safe access system 100 is illustrated. The head assembly 306 is configured similar to the head assembly 106 of FIGS. 2-3 except the head assembly 306 includes a removable arm 372 that pivots about a vertical axis C rather than a horizontal axis A. Except for the movable arm 372 moving pivoting about a vertical axis C, the description of the head assembly 106 applies equally to the head assembly 306. For example, in some implementations, the head assembly 306 includes a main body 330 having an open head configuration. In some implementations, the main body 330 is formed as a U-shaped channel having a first side wall 332, a second side wall (not shown) parallel to the first side wall 332, a bottom wall 336 extending perpendicular to and connecting the first side wall 332 and the second side wall, and an open top end 338 opposite the bottom wall 336. In some implementations, the main body 330 includes a proximal end 340 configured to attach to the mounting hardware 104, or directly to the structure 102, and a distal end 342 opposite the proximal end 340.

In some implementations, the first side wall 332 and the second side wall form a vertical channel at the proximal end 340 that receives the projecting portion 118 of the mounting hardware 104. In some implementations, each of the first side wall 332 and the second side wall includes mounting holes 346 for attaching the head assembly 306 to the mounting hardware 104. The attachment configuration for attaching the head assembly 306 to the mounting hardware 104 described above is a standardized or universal configuration. For example, in some implementations, the attachment configuration meets the Telecommunications Industry Association (TIA) 222 standard. In particular, the mounting holes 346 are vertically spaced apart at 4 inches center-to-center and configured to receive two 0.5-inch diameter fasteners (e.g., bolts). Since the type of mounting hardware varies based on what type of structure is being accessed, having a universal configuration between the head assembly 106 to the mounting hardware 104 allows the head assembly 106 to be used with the different mounting hardware for the various structures. In other implementations, the attachment configuration may not be a universal configuration but customized or specialized for a specific application.

In the illustrated implementation, the head assembly 306 includes a first connector 350 configured to support the vertical lifeline 108 at a fixed position. In the illustrated implementation the first connector 350 is an eye bolt. In other implementations, however, the first connector 350 can be any suitable connector. In the illustrated implementation, the first connector 350 is positioned adjacent the proximal end 340 in the bottom wall 336 such that the vertical lifeline 108 can attach to the bottom of the head assembly 306. The first connector 350 must be properly load rated for use as a vertical lifeline top anchor. In some implementations, the first connector 350 has a load rating of 5000 lbf (22.2 kN) or greater, 5250 lbf (23.4 kN) or greater, or 5500 lbf (24.5 kN) or greater. In some implementations, the first connector 350 has a load rating of twice the maximum arresting force (i.e., the peak dynamic force exerted on a body while a fall is being arrested) or greater. In some implementations, the first connector 350 meets the Personal Fall Arrest System requirements defined by ANSI/ASSP Z359 standard (2023).

In some implementations, the head assembly 306 is configured such that the first connector 350 is load dampened. For example, in some implementations, the first connector 350 includes a shaft 352 that extends upward into the U-shaped channel 331 between the first side wall 332 and the second side wall 334. In some implementations, a biasing element 354 can be received onto the shaft 352 and sandwiched between the bottom wall 336 and a stop 356. In some implementations, the shaft 352 has exterior threads and the stop 356 is a nut threadably coupled with the shaft 352.

The biasing element 354 can be configured in a variety of ways (e.g., spring, elastomeric sleeve, bellows, etc.). In some implementations, the biasing element 354 is a metal coil spring. Due to prolonged exposure to environmental elements in many of the applications for the safe access system, use of a metal biasing element can provide improved durability as compared to a rubber or synthetic material.

In some implementations, the head assembly 306 includes a second connector 360 configured to support the power ascender line 110 or the back-up safety line 115 at a fixed position. In some implementations, the second connector 360 is an eye bolt. In other implementations, however, the second connector 360 can be any suitable connector. In some implementations, the second connector 360 can include a biasing element (not shown) in a similar manner as described for the first connector 350, in order to provide a tensile force to the power ascender back-up safety line 115. In some implementations, the second connector 360 is positioned toward or adjacent the distal end 342 in the bottom wall 336 such that the power ascender line 110, or the back-up safety line 315, can attach to the bottom of the head assembly 306. In some implementations, the second connector 360 is properly load rated for use as a power ascender top anchor. In some implementations, the second connector 360 has a load rating of 3600 lbf (16.0 kN) or greater, 4000 lbf (17.8 kN) or greater, or 4500 lbf (20.0 kN) or greater. In some implementations, the second connector 160 has a load rating in the range of 3600 lbf (16.0 kN) to 5000 lbf (22.2 kN).

In some implementations, the second connector 360 includes a shaft 362 that extends upward into the U-shaped channel between the first side wall 332 and the second side wall and is connected to a stop 366. In some implementations, the shaft 362 has an exterior thread and the stop 366 is a nut 366 is threadably received onto the shaft 362 to secure the second connector 360 to the main body 330.

The second connector 360 is spaced apart from the first connector 350 on the bottom wall 336 a distance D1. The distance D1 can be any suitable distance. In some implementations, the distance D1 is sufficient to prevent the vertical lifeline 108 and the power ascender line 110, or the back-up safety line 315, from becoming entangled with each other during use. In addition, the distance D1 is also sufficient to allow use of a power ascender (not shown) with the power ascender line 110 without the power ascender (not shown) contacting the vertical lifeline 108 during use. Thus, the distance D1 can be selected as required for proper operation of a specific power ascender and to ensure proper line management (i.e., avoiding lines becoming entangled). In some implementations, the distance D1 is in the range of 3 inches to 36 inches, in the range of 5 to 30 inches, or in the range of 10 to 25 inches. In some implementations, the distance D1 is 3 inches or greater, 5 inches or greater, or 10 inches or greater.

In some implementations, the head assembly 306 includes a third connector 370 configured to support the power ascender line 110 at a fixed position. The third connector 370 can be used as an alternative connector to the second connector 360 for the power ascender line 110. In some implementations, the third connector 370 is an eye bolt. In other implementations, however, the third connector 370 can be any suitable connector, such as for example, a swaged connector, such as for example, a swaged connector, shackle, clevis, carabiner, quick connect link, or other suitable personal protective equipment or material handling rigging attachments.

In some implementations, the third connector 370 is positioned on the movable arm 372. The movable arm 372 can be configured to position the third connector 370 distally outward from the distal end 342 of the main body 330. In some implementations, the movable arm 372 is formed as a rectangular or square tube having a proximal end 374, and a distal end 376 opposite the proximal end 374. In some implementations, the movable arm 372 can be fixably attached to a vertical pivot rod 377. The vertical pivot rod 377 is pivotably attached to the main body 330 to pivot about the vertical axis C. The vertical pivot rod 377 can pivotably attach to the main body 330 in any suitable manner. In some implementations, the vertical pivot rod 377 includes a first end 378 the extends through the bottom wall 336 and is held in place by a nut 366 that is threadably received on the first end 378.

The vertical pivot rod 377 includes a second end 380 opposite the first end 378. The second end 380 extends upward from the open top end 338. In some implementations, the movable arm 372 is fixably mounted to the vertical pivot rod 377 at a location between the first end 378 and the second end 380 adjacent the open top end 338. In some implementations, the movable arm 372 extends at a right angle to the vertical pivot rod 377 and an angle reinforcement member 382 extends between the movable arm 372 and the vertical pivot rod 377 to provide support.

In some implementations, the third connector 370 is positioned at or near the distal end 376 of the movable arm 372 such that eyelet is facing downward. The third connector 370 is positioned on the movable arm 372 a distance D2 from the distal end 342 of the main body 330. The distance D2 can be selected as required for proper operation of a specific power ascender and to ensure proper line management (i.e., avoiding lines becoming entangled). In some implementations, the distance D2 is in the range of 3 inches to 30 inches, in the range of 8 inches to 36 inches, in the range of 10 inches to 36 inches, or in the range of 12 inches to 36 inches. In some implementations, the distance D2 is 3 inches or greater, 8 inches or greater, 10 inches or greater, or 12 inches or greater.

In use, the movable arm 372 can swing about the axis C to reposition the power ascender line 110 along an arc, which can help avoid obstructions on the structure 102 while ascending and descending. In addition, the movable arm 372 can allow a user to access work on an adjacent side of the structure from the side to which the head assembly 306 is mounted.

The second connector 360 or the third connector 370 can also be used as a safety tie-off transition point. A safety tie-off transition point is an anchor location that can be used should the user need to leave the vertical lifeline 108, such as for example, to work at a location on the structure off of the defined climb path. In such a situation, the user's safety harness would have a lanyard, for example, with one end connected to the safety harness (e.g., via a D-ring) and the other end able to attach to the safety tie-off transition point. Once connected to the safety tie-off transition point, the user can disconnect from the vertical lifeline 108 and perform the necessary operations. Thus, the head assembly 306 provides a safety tie-off transition point (e.g., the second connector) along with a vertical lifeline connector (i.e., the first connector) and a power ascender line connector (e.g., the third connector).

Furthermore, the second connector 360 can be configured for use as a support for a back-up safety line 115 at a fixed position. For example, the first connector 350 can be configured to support the vertical lifeline 108, the third connector 370 can be configured to support the power ascender line 110, and the second connector 360 can be used to support a back-up safety line 115. The back-up safety line 115 can be a variety of line types, such as high strength polyester rope, synthetic rope, wire rope, webbing, or other suitable flexible line type. The second connector 115 can be suitable for connecting to any suitable vertical lifeline type.

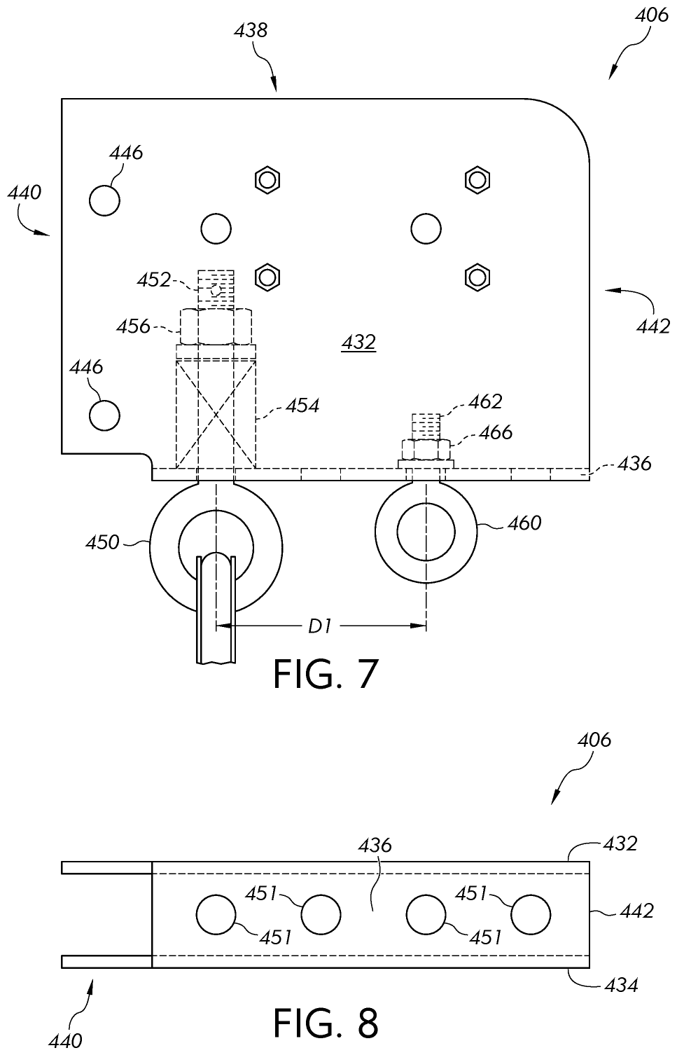

Referring to FIGS. 7-8, an example head assembly 406 for the safe access system 100 is illustrated. The head assembly 406 is configured similar to the head assembly 106 of FIGS. 2-3 except the head assembly 406 does not include a movable arm and includes multiple locations for connectors of the vertical lifeline 108, power ascender line 110, and back-up safety line 115 to be positioned. Except for these differences, the description of the head assembly 106 applies equally to the head assembly 406. For example, in some implementations, the head assembly 406 has an open head configuration. In some implementations, the head assembly 406 includes a main body 430 formed as a U-shaped channel having a first side wall 432, a second side wall 434 parallel to the first side wall 432, a bottom wall 436 extending perpendicular to and connecting the first side wall 432 and the second side wall 434, and an open top end 438 opposite the bottom wall 436. In some implementations, the main body 430 can include a proximal end 440 configured to attach to the mounting hardware 104, or directly to the structure 102, and a distal end 442 opposite the proximal end 440.

In some implementations, the first side wall 432 and the second side wall 434 form a vertical channel at the proximal end 440 that receives the projecting portion 118 of the mounting hardware 104. In some implementations, each of the first side wall 432 and the second side wall 434 include a pair of mounting holes 446 for attaching the head assembly 406 to the mounting hardware 104. In some implementations, the attachment configuration for attaching the head assembly 406 to the mounting hardware 104 is a standardized or universal configuration. For example, in some implementations, the attachment configuration meets the Telecommunications Industry Association (TIA) 222 standard. In particular, the mounting holes 446 are vertically spaced apart at 4 inches center-to-center and configured to receive two 0.5-inch diameter fasteners (e.g. bolts). Since the type of mounting hardware varies based on what type of structure is being accessed, having a universal configuration between the head assembly 106 to the mounting hardware 104 allows the head assembly 106 to be used with the different mounting hardware for the various structures. In other implementations, the attachment configuration may not be a universal configuration but customized or specialized for a specific application.

In some implementations, the head assembly 406 includes a first connector 450 configured to support the vertical lifeline 108 at a fixed position. In some implementations, the first connector 450 is an eye bolt. In other implementations, however, the first connector 450 can be any suitable connector, such as for example, a swaged connector, such as for example, a swaged connector, shackle, clevis, carabiner, quick connect link, or other suitable personal protective equipment or material handling rigging attachments.

In some implementations, the first connector 450 is positioned adjacent the proximal end 440 in the bottom wall 436 such that the vertical lifeline 108 can attach to the bottom of the head assembly 406. In some implementations, the first connector 450 is properly load rated for use as a vertical lifeline top anchor. In some implementations, the first connector 450 has a load rating of 5000 lbf (22.2 kN) or greater, 5250 lbf (23.4 kN) or greater, or 5500 lbf (24.5 kN) or greater. In some implementations, the first connector 450 has a load rating of twice the maximum arresting force (i.e., the peak dynamic force exerted on a body while a fall is being arrested) or greater.

In some implementations, the head assembly 406 is configured such that the first connector 450 is load dampened. For example, in some implementations, the first connector 450 includes a shaft 452 that extends upward into the U-shaped channel between the first side wall 432 and the second side wall 434. In some implementations, a biasing element 454 can be received onto the shaft 452 and sandwiched between the bottom wall 436 and a stop 456. In some implementations, the shaft 432 has exterior threads and the stop 456 is a nut threadably coupled with the shaft 452. The biasing element 454 can be configured in a variety of ways (e.g., spring, elastomeric sleeve, bellows, etc.). In some implementations, the biasing element 454 is a metal coil spring.

In some implementations, the head assembly 406 includes a second connector 460 configured to support the power ascender line 110 at a fixed position. In some implementations, the second connector 460 is an eye bolt. In other implementations, however, the second connector 460 can be any suitable connector such as for example, a swaged connector, such as for example, a swaged connector, shackle, clevis, carabiner, quick connect link, or other suitable personal protective equipment or material handling rigging attachments.

In some implementations, the second connector 460 is positioned toward or adjacent the distal end 442 in the bottom wall 436 such that the power ascender line 110 can attach to the bottom of the head assembly 406. In some implementations, the second connector 460 is properly load rated for use as a power ascender top anchor. In some implementations, the second connector 460 has a load rating of 3600 lbf (16.0 kN) or greater, 4000 lbf (17.8 kN) or greater, or 4500 lbf (20.0 kN) or greater. In some implementations, the second connector 160 has a load rating in the range of 3600 lbf (16.0 kN) to 5000 lbf (22.2 kN).

In some implementations, the second connector 460 includes a shaft 462 that extends upward into the U-shaped channel between the first side wall 432 and the second side wall 434. In some implementations, a nut 466 is threadably received onto the shaft 462 to secure the second connector 460 to the main body 430. The second connector 460 is spaced apart from the first connector 450 on the bottom wall 436 a distance D1. The distance D1 can be any suitable distance. In some implementations, the distance D1 is sufficient to prevent the vertical lifeline 108 and the power ascender line 110 from becoming entangled with each other during use. In addition, the distance D1 is also sufficient to allow use of a power ascender (not shown) with the power ascender line 110 without the power ascender (not shown) contacting the vertical lifeline 108 during use. Thus, the distance D1 can be selected as required for proper operation of a specific power ascender and to ensure proper line management (i.e., avoiding lines becoming entangled). In some implementations, the distance D1 is in the range of 3 inches to 36 inches, in the range of 5 inches to 30 inches, or in the range of 10 inches to 25 inches. In some implementations, the distance D1 is 3 inches or greater, 5 inches or greater, or 10 inches or greater.

In the illustrated implementation, the bottom wall 436 include a plurality of mounting holes 451 that can be used for mounting the first and second connectors 450, 460 to the main body 430. Thus, the distance D1 can be modified in different implementations as desired. In the illustrated implementation, the bottom wall 436 includes four mounting holes 451 in series. In other implementations, however, the number of mounting holes 451 can be greater or less than four and the mounting holes 451 can be arranged in any suitable pattern or manner. Further, in some implementations, more than or less than two connectors can be used. For example, in some implementations, the head assembly 406 can include only one connector (e.g., the first connector 450 attached to the vertical lifeline 108. In addition, in some implementations, the head assembly 406 can include additional connectors (e.g., a connector configured for use as a safety tie-off transition point, a connector configured to attach to a back-up safety line, etc.).

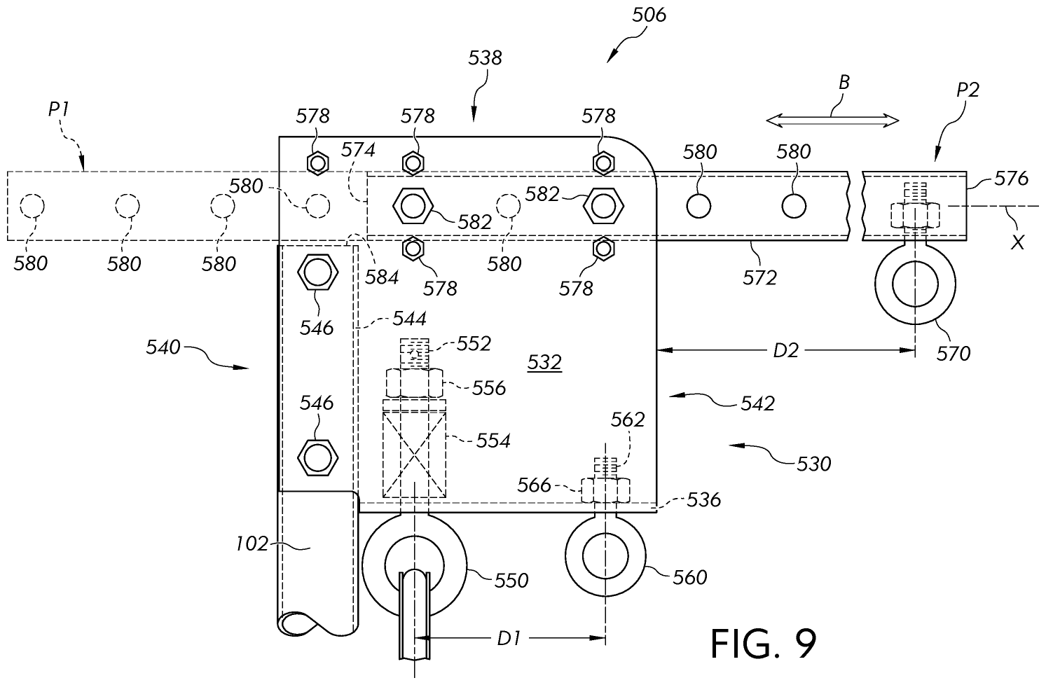

Referring to FIG. 9, an example head assembly 506 for the safe access system 100 is illustrated. The head assembly 506 is configured similar to the head assembly 106 of FIGS. 2-3 except the head assembly 506 includes an axially movable arm 572. Except for the axially movable arm 572, the description of the head assembly 106 applies equally to the head assembly 506. For example, in some implementations, the head assembly 506 has an open head configuration. In some implementations, the head assembly 506 includes a main body 530 formed as a U-shaped channel having a first side wall 532, a second side wall (not shown) parallel to the first side wall 532, a bottom wall 536 extending perpendicular to and connecting the first side wall 532 and the second side wall (not shown), and an open top end 538 opposite the bottom wall 536. In some implementations, the main body 530 includes a proximal end 540 configured to attach to the mounting hardware 104, or directly to the structure 102, and a distal end 542 opposite the proximal end 540.

In some implementations, the first side wall 532 and the second side wall (not shown) form a vertical channel 544 at the proximal end 540 that receives the projecting portion of the mounting hardware 104 or a portion of the structure 102. In some implementations, each of the first side wall 532 and the second side wall (not shown) include a pair of mounting holes 546 for attaching the head assembly 506 to the mounting hardware 104. In some implementations, the attachment configuration for attaching the head assembly 506 to the mounting hardware 104 or a portion of the structure 102 is a standardized or universal mounting configuration. For example, in some implementations, the attachment configuration meets the Telecommunications Industry Association (TIA) 222 standard. In particular, the mounting holes 446 are vertically spaced apart at 4 inches center-to-center and configured to receive two 0.5-inch diameter fasteners (e.g., bolts). Since the type of mounting hardware varies based on what type of structure is being accessed, having a universal configuration between the head assembly 106 to the mounting hardware 104 allows the head assembly 106 to be used with the different mounting hardware for the various structures. In other implementations, the attachment configuration may not be a universal configuration but customized or specialized for a specific application.

In some implementations, the head assembly 506 includes a first connector 550 configured to support the vertical lifeline 108 at a fixed position. In some implementations, the first connector 550 is an eye bolt. In other implementations, however, the first connector 550 can be any suitable connector, such as for example, a swaged connector, such as for example, a swaged connector, shackle, clevis, carabiner, quick connect link, or other suitable personal protective equipment or material handling rigging attachments.

In some implementations, the first connector 550 is positioned adjacent the proximal end 540 in the bottom wall 536 such that the vertical lifeline 108 can attach to the bottom of the head assembly 506. In some implementations, the first connector 550 is properly load rated for use as a vertical lifeline top anchor. In some implementations, the first connector 550 has a load rating of 5000 lbf (22.2 kN) or greater, 5250 lbf (23.4 kN) or greater, or 5500 lbf (24.5 kN) or greater. In some implementations, the first connector 550 has a load rating of twice the maximum arresting force (i.e., the peak dynamic force exerted on a body while a fall is being arrested) or greater.

In some implementations, the head assembly 506 is configured such that the first connector 550 is load dampened. For example, in some implementations, the first connector 550 includes a shaft 552 that extends upward into the U-shaped channel between the first side wall 532 and the second side wall. In some implementations, a biasing element 554 can be received onto the shaft 552 and sandwiched between the bottom wall 536 and a stop 556. In some implementations, the shaft 532 has exterior threads and the stop 556 is a nut threadably coupled with the shaft 552. The biasing element 554 can be configured in a variety of ways (e.g., spring, elastomeric sleeve, bellows, etc.). In some implementations, the biasing element 554 is a metal coil spring.

In some implementations, the head assembly 506 includes a second connector 560 configured to support the power ascender line 110, or a power ascender back-up safety line 115, at a fixed position. In some implementations, the second connector 560 is an eye bolt. In other implementations, however, the second connector 560 can be any suitable connector such as for example, a swaged connector, such as for example, a swaged connector, shackle, clevis, carabiner, quick connect link, or other suitable personal protective equipment or material handling rigging attachments.

In some implementations, the second connector 560 is positioned toward or adjacent the distal end 542 in the bottom wall 536 such that the power ascender line 110 can attach to the bottom of the head assembly 506. In some implementations, the second connector 560 is properly load rated for use as a power ascender top anchor. In In some implementations, the second connector 560 has a load rating of 3600 lbf (16.0 kN) or greater, 4000 lbf (17.8 kN) or greater, or 4500 lbf (20.0 kN) or greater. In some implementations, the second connector 160 has a load rating in the range of 3600 lbf (16.0 kN) to 5000 lbf (22.2 kN).

In some implementations, the second connector 560 includes a shaft 562 that extends upward into the U-shaped channel between the first side wall 532 and the second side wall (not shown). In some implementations, the shaft 562 has an exterior thread and a nut 566 is threadably received onto the shaft 562 to secure the second connector 560 to the main body 530. The second connector 560 is spaced apart from the first connector 550 on the bottom wall 536 a distance D1. The distance D1 can be any suitable distance. In some implementations, the distance D1 is sufficient to prevent the vertical lifeline 108 and the power ascender line 110 from becoming entangled with each other during use. In addition, the distance D1 is also sufficient to allow use of a power ascender (not shown) with the power ascender line 110 without the power ascender (not shown) contacting the vertical lifeline 108 during use. Thus, the distance D1 can be selected as required for proper operation of a specific power ascender and to ensure proper line management (i.e., avoiding lines becoming entangled). In some implementations, the distance D1 is in the range of 3 inches to 36 inches, in the range of 5 inches to 30 inches, or in the range of 10 inches to 25 inches. In some implementations, the distance D1 is 3 inches or greater, 5 inches or greater, or 10 inches or greater.

In some implementations, the head assembly 506 includes a third connector 570 configured to support the power ascender line 110 at a fixed position. The third connector 570 can be used as an alternative connector to the second connector 560 for the power ascender line 110. In some implementations, the third connector 570 is an eye bolt. In other implementations, however, the third connector 570 can be any suitable connector, such as for example, a swaged connector, such as for example, a swaged connector, shackle, clevis, carabiner, quick connect link, or other suitable personal protective equipment or material handling rigging attachments.

In some implementations, the third connector 570 is positioned on an axially movable arm 572. The movable arm 572 is configured to position the third connector 570 distally outward from the distal end 542 of the main body 530. The movable arm 572 can be configured in a variety of ways, including, but not limited to the size, length, and cross-section shape of the movable arm 572. In some implementations, the movable arm 572 is formed as a rectangular or square tube having a longitudinal axis X, a proximal end 574, and a distal end 576 opposite the proximal end 574. In some implementations, the movable arm 572 is configured to slide axially relative to the main body 530 (shown by arrows B in FIG. 9) between a retracted first position P1 (shown as dashed lines in FIG. 9), an extended second position P2 (shown as solid lines in FIG. 9), and one or more intermediate positions between the first position P1 and the second position P2. In some implementations, the main body 530 includes a plurality of guide pins 578 that support the movable arm 572 is a generally horizontal position while allowing the movable arm 572 to move between the various positions.

In some implementations, the movable arm 572 can be configured to lock in the first position P1, the second position P2, or any of the intermediate positions. In some implementations, the movable arm 572 includes a plurality of cross holes 580 that aligns with locking apertures 582 in the main body 530 when the movable arm 572 is installed. Fasteners (e.g., a bolts) can be received through the cross holes 580 and locking apertures 582 to lock the movable arm 572 in any of the desired positions.

In some implementations, the third connector 570 is positioned at or near the distal end 576 of the movable arm 572 such that the eyelet, or other connection point, is facing downward (similar direction to the first and second connectors). The third connector 570 is positioned on the movable arm 572 a distance D2 from the distal end 542 of the main body 530. The distance D2 can be selected as required for proper operation of a specific power ascender and can be modified by moving the movable arm 572 axially relative to the main body 530 between the various positions. In some implementations, the distance D2 is in the range of 0 inches to 36 inches, in the range of 8 inches to 36 inches, in the range of 10 inches to 36 inches, or in the range of 12 inches to 36 inches. In some implementations, the distance D2 is 0 inches or greater, 8 inches or greater, 10 inches or greater, or 12 inches or greater.

In use, the movable arm 572 can be installed such that the third connector 570 is positioned outward from the main body 530 of the head assembly 506 to provide additional spacing for the power ascender line 110 to avoid obstructions on the structure 102 along the climb path. When the third connector 570 is not used, the movable arm 572 can be axially retracted into the main body 530 such that the distal end 576 of the movable arm 572 is within, or minimally extending from, the main body 530. As shown in FIG. 9, in some implementations, in order to allow space for the movable arm 572 to move to a retracted position, the head assembly 506 may need to mount to a terminal end 584 of the structure 102 or the mounting hardware 104.

In some implementations, the second connector 560 or the third connector 570 can be configured for use as a safety tie-off transition point. A safety tie-off transition point is an anchor location that can be used should the user need to leave the vertical lifeline 108, such as for example, to work at a location on the structure off of the defined climb path. In such a situation, the user's safety harness would have a lanyard, for example, with one end connected to the safety harness (e.g., via a D-ring) and the other end able to attach to the safety tie-off transition point. Once connected to the safety tie-off transition point, the user can disconnect from the vertical lifeline 108 and perform the necessary operations. Thus, the head assembly 506 provides a safety tie-off transition point (e.g., the second connector) along with a vertical lifeline connector (i.e., the first connector) and a power ascender line connector (e.g., the third connector).

Furthermore, in some implementations, the second connector 560 can be configured for use as a support for a back-up safety line 115 at a fixed position. For example, the first connector 550 can be configured to support the vertical lifeline 108, the third connector 570 can be configured to support the power ascender line 110, and the second connector 560 can be used to support a back-up safety line 115. The back-up safety line 115 can be a variety of line types, such as high strength polyester rope, synthetic rope, wire rope, webbing, or other suitable flexible line type. The second connector 115 can be suitable for connecting to any suitable vertical lifeline type. In some implementations, the second connector 560 can include a biasing element (not shown) in a similar manner as described for the first connector 550, in order to provide a tensile force to the power ascender back-up safety line 115.

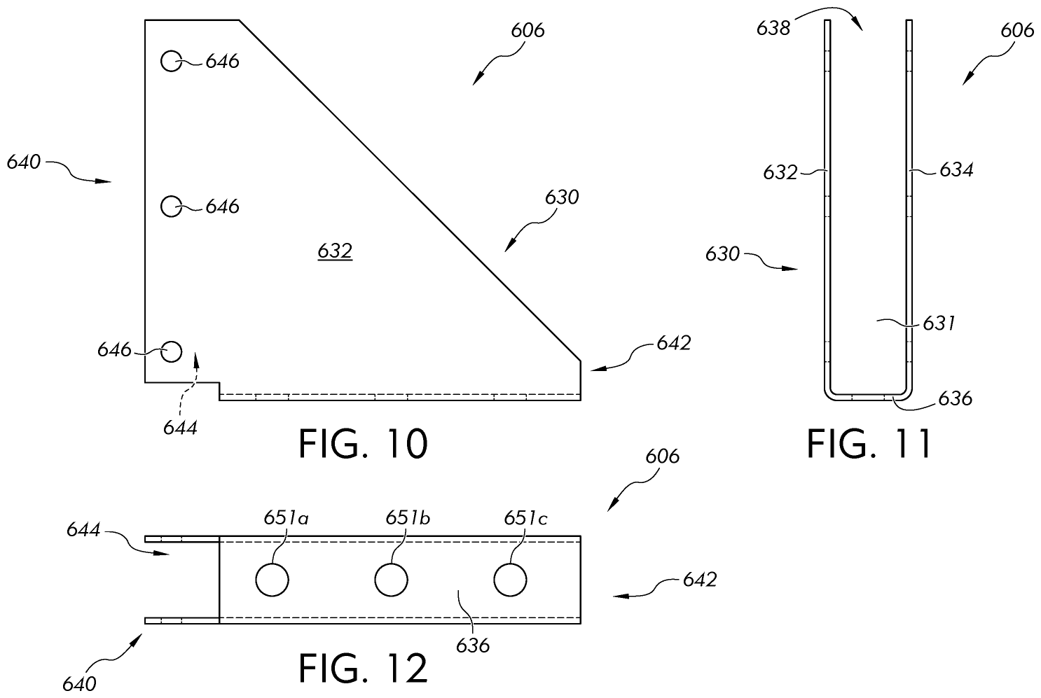

Referring to FIGS. 10-12, an example head assembly 606 for the safe access system 100 is illustrated. The head assembly 606 is configured similar to the head assembly 606 of FIGS. 2-3 except the head assembly 606 does not include a movable arm and includes one or more locations for one more connectors (e.g., for a vertical lifeline, a power ascender line, a power ascender back-up safety line, a safety tie-off transition point, etc.) to be positioned. Except for these differences, the description of the head assembly 106 applies equally to the head assembly 606. For example, in some implementations, the head assembly 606 has an open head configuration. In some implementations, the head assembly 606 includes a main body 630 formed as a U-shaped channel 631 having a first side wall 632, a second side wall 634 parallel to the first side wall 632, a bottom wall 636 extending perpendicular to and connecting the first side wall 632 and the second side wall 634, and an open top end 638 opposite the bottom wall 636. In some implementations, the main body 630 includes a proximal end 640 configured to attach to the mounting hardware 104, or directly to the structure 102, and a distal end 642 opposite the proximal end 640.

In some implementations, the first side wall 632 and the second side wall 634 form a vertical channel 644 at the proximal end 640 that receives the projecting portion 118 of the mounting hardware 104. Each of the first side wall 632 and the second side wall 634 can include a plurality of mounting holes 646 for attaching the head assembly 606 to the mounting hardware 104. In some implementations, the attachment configuration for attaching the head assembly 606 to the mounting hardware 104 described above is a standardized or universal configuration. For example, in some implementations, the attachment configuration meets the Telecommunications Industry Association (TIA) 222 standard. In particular, the mounting holes 646 are vertically spaced apart at 4 inches center-to-center and configured to receive two 0.5-inch diameter fasteners (e.g., bolts). Since the type of mounting hardware varies based on what type of structure is being accessed, having a universal configuration between the head assembly 106 to the mounting hardware 104 allows the head assembly 106 to be used with the different mounting hardware for the various structures. In other implementations, the attachment configuration may not be a universal configuration but customized or specialized for a specific application.

In some implementations, the bottom wall 636 includes one or more mounting holes or other mounting structure that can be used for mounting the connectors (e.g., connectors 150, 160, 170) to the main body 630. In some implementations, the bottom wall 636 includes a first mounting hole 651a, a second mounting hole 651b, and a third mounting hole 651c in series. In other implementations, however, the number of mounting holes can be greater or less than three and the mounting holes can be arranged in any suitable pattern or manner.

The mounting holes 651a, 651b, 651c can be configured to support any suitable connectors, such as for example, an eye bolt, a swaged connector, shackle, clevis, carabiner, quick connect link, or other suitable personal protective equipment or material handling rigging attachments. In some implementations, the first mounting hole 651a is positioned adjacent the proximal end 640 in the bottom wall 636 such that the vertical lifeline 108 can attach to the bottom of the head assembly 606 via a suitable connector load rated for use as a vertical lifeline top anchor. For example, suitable connectors for use as a vertical lifeline top anchor can have a load rating of 5000 lbf (22.2 kN) or greater, 5250 lbf (23.4 kN) or greater, or 5500 lbf (24.5 kN) or greater. In some implementations, a suitable connector mounted via the first mounting hole 651a can have a load rating of twice the maximum arresting force (i.e., the peak dynamic force exerted on a body while a fall is being arrested) or greater.

In some implementations, the connector mounted via the first mounting hole 651a (or any of the mounting holes) can be load dampened in the same or similar way as described regarding the first connector 150 of FIGS. 2-3. Thus, for example, a biasing element (e.g., metal coil spring) can be positioned within the main body 630 and operatively associated with the connector mounted via the first mounting hole 651a (or another of the mounting holes). In this way, the connector mounted via the first mounting hole 651a can be utilized to anchor a vertical lifeline to structure 102. In some implementations, the main body 630 may only include, or may only utilize, the first mounting hole 651a. For example, and a connector configured to support the vertical lifeline 108 at a fixed position (e.g., the same as connector 150) can be mounted via the first mounting hole 651a. Thus, the safe access system can be configured as a cable safe climb system.

In some implementations, the third mounting hole 651c is positioned toward or adjacent the distal end 642 in the bottom wall 636. The third mounting hole 651c can be configured to mount a suitable connector for supporting the power ascender line 110 at a fixed position. A suitable connector for supporting the power ascender line 110 can be properly load rated for use as a power ascender top anchor. In some implementations, the suitable connector can have a load rating of 3600 lbf (16.0 kN) or greater, 4000 lbf (17.8 kN) or greater, or 4500 lbf (20.0 kN) or greater. In some implementations, the second connector 160 has a load rating in the range of 3600 lbf (16.0 kN) to 5000 lbf (22.2 kN).

In some implementations, the second mounting hole 651b is positioned between the first mounting hole 651a and the second mounting hole 651c in the bottom wall 636. In some implementations, the second mounting hole 651c is configured to mount a suitable connector for a safety tie-off transition point. A safety tie-off transition point is an anchor location that can be used should the user need to leave the vertical lifeline 108, such as for example, to work at a location on the structure off of the defined climb path. In such a situation, the user's safety harness would have a lanyard, for example, with one end connected to the safety harness (e.g., via a D-ring) and the other end able to attach to the safety tie-off transition point. Once connected to the safety tie-off transition point, the user can disconnect from the vertical lifeline 108 and perform the necessary operations. Thus, the head assembly 606 can provide a safety tie-off transition point (e.g., at the second mounting hole 651b) along with a vertical lifeline connector (i.e., at the first mounting hole 651a) and a power ascender line connector (e.g., at the third mounting hole 651c).

Furthermore, the second mounting hole 651c can be configured to mount a suitable connector for a back-up safety line 115 at a fixed position. The back-up safety line 115 can be a variety of line types, such as high strength polyester rope, synthetic rope, wire rope, webbing, or other suitable flexible line type. The second mounting hole 651c can be configured for mounting a suitable connector for any suitable vertical lifeline type.

In some implementations, the head assembly 606 may only include, or only utilize, two mounting holes (e.g., 651b, 651c). For example, the head assembly 606 can be configured to mount a suitable connector for supporting the power ascender line 110 at a fixed position in mounting hole 651c, for example, and to mount a suitable connector for a back-up safety line 115 at a fixed position in mounting hole 651b, for example. Thus, the head assembly 606 can thus be used in conjunction with a separate cable safe climb system.

For example, generally, vertical lifelines 108 are a metal wire rope that is installed one a structure and kept permanently in place (unless maintenance is required). Power ascender lines and power ascender back-up safety lines are typically synthetic rope, which are not suited to be kept in place permanently. Thus, power ascender lines and power ascender back-up safety lines are temporarily installed and then removed once the user has, for example, descended from the structure. The head assembly 606, when configured to mount the power ascender line 110 and power ascender back-up safety line 115, can be used as a temporary mounting to access the structure 102. For example, a user can access the structure via a climb path while utilizing a vertical lifeline 108 and carrying the head assembly 606. The user can then mount the head assembly 606 on the structure in order to provide a power ascender line 110 and power ascender back-up safety line 115 for the user to use in subsequent climbs and/or for other users to use to access the structure.

While the head assemblies 106, 206, 306, 406, 506, 606 described in the present application are described in relation to use as a top anchorage, the head assemblies 106, 206, 306, 406, 506, 606 may also be used as a bottom anchorage for the vertical lifeline 108 and/or the back-up safety line 115. In use, the vertical lifeline 108 and the back-up safety line 115 need to be is held in tension, and therefore are anchored at both the top and the bottom of each of the vertical lifeline 108 and the back-up safety line 115. The disclosed head assemblies 106, 206, 306, 406, 506, 606 are designed to be versatile and able to function as both a top anchor and a bottom anchor. In some implementations, when used as a bottom anchor, the disclosed head assemblies 106, 206, 306, 406, 506, 606 are inverted. Any combination or sub-combination of the features of any of the head assemblies disclosed herein can be combined with, substituted for, and/or added to any of the head assemblies discussed in the present application.

What has been described above includes examples of one or more implementations. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A safe access system, comprising:
a main body configured to attach to mounting hardware on a structure to be accessed;
a first connector attached to the main body and configured for connecting to a vertical lifeline; and
a second connector attached to the main body and configured for connecting to a power ascender line.

2. The safe access system according to claim 1, wherein the second connector is positioned on an arm pivotable about a horizontal axis between a first upright position and a second extended position.

3. The safe access system according to claim 1, wherein the second connector is positioned on an arm pivotable about a vertical axis.

4. The safe access system according to claim 1, wherein the second connector is positioned on an arm that is axially moveable along a longitudinal axis of the arm between a first retracted position and a second extended position.

5. The safe access system according to claim 4, wherein the arm is slidable along a longitudinal axis of the arm between one or more intermediate positions between the first retracted position and the second extended position, and wherein the arm is configured to lock the first retracted position, the second extended position, and the one or more intermediate positions.

6. The safe access system according to claim 1, wherein the first connector is operatively connected to a coil spring for dampening a load applied to the first connector.

7. The safe access system according to claim 6, wherein the coil spring is configured to apply a tensile force to the vertical lifeline.

8. (canceled)

9. The safe access system according to claim 1, wherein the first connector is spaced apart from the second connector a distance in the range of 3 inches to 30 inches.

10. The safe access system according to claim 1, wherein the main body has a proximal end that attaches to the mounting hardware and a distal end opposite the proximal end, and wherein the second connector is spaced distally from the distal end a distance in the range of 12 inches to 36 inches.

11. The safe access system according to claim 1, further comprising a third connector attached to the main body and configured for use as a safety tie-off transition point or as back-up safety line.

12. The safe access system of claim 1, wherein the main body has an open head configuration to allow for visual inspection of the first connector and second connector.

13. The safe access system of claim 1, wherein the main body is configured to have a universal mounting configuration for attaching to the mounting hardware.

14. A method of anchoring a vertical lifeline and a power ascender line at the top of a climb path on a structure, the method comprising:
attaching a head assembly having a main body to mounting hardware on the structure;
attaching the vertical lifeline to the main body at a first location; and
attaching the power ascender line to the main body at a second location.

15. The method of anchoring according to claim 14, further comprising dampening a load on the vertical lifeline with a biasing element positioned with the main body.

16. The method of anchoring according to claim 14, wherein the second location is located on a movable arm.

17. The method of anchoring according to claim 16, further comprising pivoting the movable arm to an extended position.

18. The method of anchoring according to claim 17, further comprising sliding the movable arm along a longitudinal axis to a plurality of positions relative to the main body.

19. The method of anchoring according to claim 18, further comprising locking the moveable arm in one of the plurality of positions.

20. (canceled)

21. The method of anchoring according to claim 14, further comprising attaching at least one of a safety tie off and a power ascender back-up safety line to the main body at a third location.

22. (canceled)

23. The method of anchoring according to claim 14, further comprising applying a tensile force to the vertical lifeline.
